(19) United States
(12) Patent Application Publication
(10) Pub. No.: US 2008/0233080 A1
(43) Pub. Date: Sep. 25, 2008

(54) Inulins, Levans, Fructans And Other Smaller-Than-Cellulose Termite Feeding Attractants, And Termite

(76) Inventors: Rachael Perrott, Ashburn, VA (US); Dini M. Miller, Radford, VA (US); Donald E. Mullins, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 10/599,037

(22) PCT Filed: Mar. 22, 2005
(86) PCT No.: PCT/US05/09348

§ 371 Date: May 27, 2008

Related U.S. Application Data
(60) Provisional application No. 60/554,988, filed on Mar. 22, 2004.

(51) Int. Cl. A01N 25/00; A01M 99/00

(52) U.S. Cl. 424/84; 119/712; 43/58

(57) ABSTRACT

The present invention discloses Resistance Management (RM) practices that are critical to safeguarding Bacillus thuringiensis as a natural resource and to sustaining genetically modified crops that express Bt toxins for managing ECB and WCRW. The methods involve blending seed transformed with a nucleic acid encoding a different pesticidal protein, where both proteins target the same pest, but use different modes of pesticidal action. The seed can be also treated with pesticidal agents.

### FIELD OF THE INVENTION

The present invention is directed to termite behavior such as termite food preferences and termite baiting, especially regarding subterranean termites.

### BACKGROUND OF TILE INVENTION

Subterranean termites are the single most important structural pest in the United States. Each year millions of dollars are spent on subterranean termite prevention, control, and damage repair. What makes these insects such significant pests is the fact that their diet consists solely of wood and other cellulose materials. In the natural environment subterranean termites provide the valuable service of recycling (consuming and digesting) dead and decayed wood and returning those nutrients to the soil. However, when humans replace natural food resources with wood homes and other structures, the termites' habit of consuming wood becomes a significant problem.

Wood is composed of cellulose (Formula 1 below) which is a natural carbohydrate high polymer (polysaccharide) of formula (C₆H₁₀O₅)ₙ. Cellulose naturally occurs in other materials besides wood, such as in cotton, etc. Cellulose in wood pulp has a relatively low molecular weight of about 160,000 Da, whereas cellulose in cotton has a higher molecular weight.

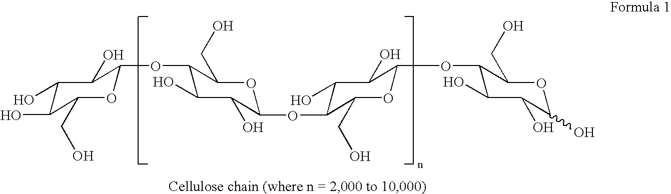

Celluloses from all sources are high molecular weight linear polysaccharides of D-glucopyranose units linked β-1→4.

There have been a number of methods used to prevent subterranean termite attack on wood structures. The oldest and most commonly used method has been the application of liquid termiticide to the soil around the structure. However, this method requires that large amounts of dilute pesticide be applied to and beneath the foundation. Many homeowners are not comfortable with the invasive application methods of liquid treatment or the toxicity of the chemicals being placed in their immediate living environment.

Therefore, another approach to termite control was developed in the 1990s to avoid the disadvantages of liquid termiticide application. This approach involved the installation of termite baiting systems. As examples of physical structures that have been disclosed for disposing termite baits, see U.S. Pat. No. 6,370,814 (issued Apr. 16, 2002 to Curtis et al.); U.S. Pat. No. 6,772,557 (issued Aug. 10, 2004 to Laskey et al.); U.S. Pat. No. 6,631,583 (issued Oct. 14, 2003 to Rollins).

Termite baiting systems are applied by installing plastic stations that contain wood blocks (monitors) into the ground around the structure. Termites tunneling in the soil encounter these stations and begin to consume the wood.

Theoretically, the termites then recruit additional termites to the bait station so that large numbers of termite workers begin feeding on the monitors. A pest management professional checks the stations monthly. When he or she finds a station that has been “hit” by termites, the wood monitor is replaced with a cellulose bait containing a toxicant. The termites in the station consume the active bait and then pass the active ingredient on to other termites in the colony via trophallaxis. In this way the toxicant is spread throughout the termite colony and large numbers of termites, and possibly the whole colony, are affected by the toxicant and killed.

For systems using wood and/or cellulose in termite baiting, see, e.g., U.S. Pat. No. 6,235,301 (issued May 22, 2001) and U.S. Pat. No. 6,071,529 (issued Jun. 6, 2000) (both to Ballard et al., for “Termite bait”); U.S. Pat. No. 6,691,453 (issued Feb. 17, 2004 to Rojas et al., titled “Naphthalenic compounds as termite bait toxicants”); U.S. Pat. No. 6,585,991 (issued Jul. 1, 2003 to Rojas et al., Titled “Termite bait matrix”); U.S. Pat. No. 6,416,752 (issued Jul. 9, 2002 to Richardson et al., titled “Termite bait composition and method”); U.S. Pat. No. 6,195,934 (issued Mar. 6, 2001) and U.S. Pat. No. 5,937,571 (issued Aug. 17, 1999) (both to Megargle et al., for “Termite bait station”); U.S. Pat. No. 6,584,728 (issued Jul. 1, 2003 to Aesch, Jr. et al., for “Termite bait station and method of service”). U.S. Pat. Application No. 20030152605 (published Aug. 14, 2003 by Martin et al. for “Optimum density termite bait composition”) discloses a cellulose material which may be purified cellulose or micro-crystalline cellulose as bait. Another attractant that has been disclosed for termite baiting is brown rot fungus. See U.S. Pat. No. 4,363,798 (issued Dec. 14, 1982 to D'Orazio for “Termite bait composition”).

In spite of the environmental friendliness and unobtrusiveness of known termite bait systems, they have several limitations, not the least of which is the small presence an individual station has in the outdoor environment. Because there is no way to direct termite foraging into the bait system it may take considerable time for termites to discover the stations. In addition, subterranean termites are known to prefer feeding on particular types of wood and wood in certain conditions of decay, in other words, wood whose chemical composition tastes better than other wood available in the same area. If these better tasting food sources are in the same location where baiting is being attempted, the preferred food sources will have a significant impact on the bait system efficacy.

Commercially available termite bait matrix systems include Sentricon Termite Elimination System (Dow AgroSciences), the FirstLine Termite Baiting System (FMC Corporation) and the Exterra Termite Baiting System (Ensystex Co.). The Sentricon Termite Elimination System, developed by Dow AgroSciences in 1994, has been marketed as a colony elimination system, meaning that once termites start eating the bait, they will carry enough of the active ingredient back to the colony to destroy the entire nest. In about 2002 the active ingredient in the Sentricon system was hexaflumuron [N-(((3,5-dichloro-4-(1,1,2,2-tetrafluoroethoxy)phenyl)-amino)carbonyl)-2,6-difluorobenzamide] which is a slow acting chitin synthesis inhibitor (Su, N.-Y. and J. F. La Fage, 1987, Effects of soldier proportion in the wood-consumption rate of the Formosan subterranean termite (Isoptera: Rhinotermitidae), Sociobiology, 13: 145-151; Nakagawa, Y., M. Matsutani, N. Kurihara, K. Nishimura, and T. Fujita, 1992, Quantitative structure-activity studies of benzoylphenylurea larvides. VIII. Inhibition of N-acetylglucosamine incorporation into the cultured integument of Chilo suppressalis Walker, Pestic. Biochem. Physiol., 43: 141-151). The mean half life of hexaflumuron within the body of a termite is ˜9 days thus foraging termites survive long enough after ingestion to transfer the toxicant to other members of the colony (Sheets, J. J., L. L. Karr, and J. E. Dripps, 2000, Kinetics of uptake, clearance, transfer, and metabolism of hexaflumuron by eastern subterranean termites (Isoptera: Rhinotermitidae), J. Econ. Entomol., 93: 871-877). However, the speed at which a termite colony is eliminated is still dependent on the number of worker termites recruited to the bait station and how much of the bait they consumed. Recently, the active ingredient of the Sentricon system has been changed to a closely related material noviflumuron (N-[[[3,5-dichloro-2-fluoro-4-(1,1,2,3,3,3-hexafluoropropoxy)phenyl]amino]carbonyl]-2,6-difluorobenzamide.

These three mentioned systems dominate the national market in the United States. However, currently, it takes weeks and often months for termites to begin feeding at the bait stations in significant numbers. As mentioned previously, bait stations have a relatively small presence (size) in the outdoor environment. Subterranean termites are known to prefer larger food sources over smaller ones (Waller, D. A., 1988, Host selection in subterranean termites: factors affecting choice (Isoptera: Rhinotermitidae), Sociobiology, 14: 5-13; Lenz, M., 1994, Food resources, colony growth, and caste development in wood feeding termites, pp. 159-209 in J. H. Hunt and C. A. Nalepa [eds.], Nourishment and evolution in insect societies, Westview Press, Boulder, Colo.; Cornelius and Osbrink 2001) and do not abandon a large food source to consume one of smaller size. Also, when bait stations are installed in the ground, subterranean termites are usually already feeding on a structure or some other food source in the area. Because termites are known to be faithful to an established food source and will not leave it until it is near depletion, there is often a considerable wait after installation before subterranean termites begin to attack bait stations (Heidecker, J. L. and R. H. Heuthold, 1984, The organization of collective foraging in the harvester termite Hodotermes mossambicus (Isoptera), Behav. Ecol. Sociobiology, 4:195-202; Oi, F. M., N.-Y. Su, P. G. Koehler, and F. Slansky, 1996, Laboratory evaluation of food placement and food types on the feeding preference of Reticulitermes virginicus (Isoptera: Rhinotermitidae), J. Econ. Entomol., 89:915-921).

In addition to the small size of the stations, many other factors influence the efficacy of bait systems. Some of these factors are related to termite behavior and others are related to the environment in which the bait systems are placed. Wood characteristics, such as density, diameter, particle size and nutritional value will influence how much and how quickly termites will consume a particular piece of wood (Behr, E. A., C. T. Behr, and L. F. Wilson, 1972, Influence of wood hardness on feeding by the eastern subterranean termite Reticulitermes flavipes (Isoptera: Rhinotermitidae), Ann. Entomol. Soc. Am., 65: 457-460; La Fage, J. P. and W. L. Nutting, 1978, Nutrient dynamics of termites, pp. 165-232 in M. V. Brian [ed.], Production ecology of ants and termites, Cambridge University Press, U.K.; Wood, T. G., 1978, Food and feeding habits of termites, pp. 55-80, in M. V. Brian [ed.], Production Ecology of Ants and Termites, Cambridge Univ. Press, London). A termite colony may become preconditioned to prefer a particular food source rather than choosing to consume a new food source which is preferred by termites of the same species. Termites are also known to prefer food that has been previously damaged by conspecific consumption and has a high (relatively) moisture content (Delaplane, K. S. and J. P. LaFage, Preference of the Formosan subterranean termite (Isoptera: Rhinotermitidae) for wood damaged by conspecifics, J. Econ. Entolmol., 82: 1363-1366, 1989; Delaplane, K. S. and J. P. LaFage, Preference for moist wood by the Formosan subterranean termite (Isoptera: Rhinotermitidae, J. Econ. Entonol., 82:95-100, 1989.) Feeding behavior can also vary with colony size. For instance, foraging distance is limited in smaller colonies, because fewer workers are available to look for food. Therefore, smaller colonies may feed on only 1 or 2 available, but not preferred, food sources (Wood 1978).

Subterranean termites are also known to consume paper, cardboard, and other forms of processed cellulose. In many cases these processed cellulose sources are consumed preferentially over natural food resources because they are easier to ingest (Suiter, D. R., S. C. Jones, and B. T. Forschler, 2002, Biology of Subterranean Termites in the Eastern United States, University of Georgia Cooperative Extension Service, Bulletin 1209). There is also natural variation in termite foraging pressure so that different termite colonies attack food and feed at different times (Su, N.-Y. and J. P. La Fage, 1984, Differences in survival and feeding activity among colonies of the Formosan subterranean termites (Isoptera: Rhinotermitidae), Z. Ang. Ent., 97: 134-138; Lenz, M., 1985, Variability of vigour between colonies of Coptotermes acinaciformis (Froggart) (Isoptera: Rhinotermitidae) and its implications for laboratory experimentation, Bull. Entomol. Res., 75:13-21). Different rates of feeding have been correlated with termite colony size, the cast proportions and the time of year (Esenther, G. R. and R. H. Beal, 1978, Insecticidal baits on field plot perimeters suppress Reticulitermes., J. Econ. Entomol., 71:604-607; Becker, G., 1962, Laboratoriumsprufung von Holz und Holzschutzmittein mit der sudasiatischen Termite Heterotermes indicola Wassman, Holz. Rho. Werkstoff, 20: 476-486; Su and LaFage 1987; Forschler, B. T., 1994, Florescent spray paint as a topical marker on subterranean termites (Isoptera: Rhinotermitidae), Sociobiology, 24:27-38). Seasonal variation in termite foraging and feeding behavior is related to several environmental conditions. Temperature (Smythe, R. V. and L. H. Williams, 1972, Feeding and survival of two subterranean termite species at constant temperatures, Ann. Entomol. Soc. Am, 65: 226-229; Haverty, M. I. and W. L. Nutting, 1974, Natural wood-consumption rates and survival of a dry-wood and a subterranean termite at constant temperatures, Ann. Entomol. Soc. Am., 67:153-157), moisture (Collins, M. S., 1969, Water relations in termites, pp. 433-438, in K. Krisha and F. M. Weesner [eds], Biology of Termites, Academic Press, NY), and ground cover (or the lack of ground cover) have well documented effects on termite foraging during the different seasons (Su and La Fage 1984; Lenz 1985; Cornelius, M. L. and W. L. A. Osbrink, 2001, Tunneling behavior, foraging tenacity, and wood consumption rates of Formosan and eastern subterranean termites (Isoptera: Rhinotermitidae) in laboratory bioassays, Sociobiology, 37:79-94).

In a situation where a termite population does establish a bait station as a suitable food resource, the amount of bait consumed and its subsequent efficacy would depend, generally speaking, on how many workers were recruited to the bait station, how many other food sources the colony was currently consuming, and the palatability of any food resources located by the termites in the future.

Thus, developing new, effective termite control approaches has been difficult. There remains room for improvement in termite baiting, such as the desirability of reducing the long amount of time (on the order of weeks and even months) currently needed before termites begin feeding at the bait stations in significant numbers, recruiting additional termites to the bait stations, creating a bait matrix that is more palatable than competing food resources in the same area.

### SUMMARY OF THE INVENTION

The present invention exploits the unexpected discovery that, surprisingly, termites proved to be affirmatively attracted to controls containing radiolabeled (³H) inulin (which is a β-linked carbohydrate). Thus, β-linked carbohydrates smaller than cellulose are now provided, in the invention, as termite attractants for termite baiting.

Notably, the present invention provides methods of manipulating termite behavior, especially feeding behavior of subterranean termites. The inventive manipulation methods are highly suited to manage termite problems, such as enticing termites to preferentially consume the bait over competing food resources (structures).

In one preferred embodiment, the invention provides a termite baiting composition, comprising a termite food source that (1) to a termite (such as, preferably, a subterranean termite) is not naturally already available as a building or as a living or dead plant; and (2) is easier for the termite to digest compared to a naturally available diet of the termite, such as, e.g., a termite baiting composition wherein the easier-to-digest material is smaller than cellulose; a termite baiting composition wherein the easier-to-digest material comprises at least one β-linked carbohydrate; a termite baiting composition wherein the easier-to-digest material is digestible only by termites including digestion by organisms within termites; a termite baiting composition comprising at least one plant-derived β-linked hexose polymer; a termite baiting composition wherein the easier-to-digest material includes one or both selected from the group consisting of β-2→1 linkages and β-2→6 linkages (such as, e.g., a termite baiting composition wherein a maximum molecular weight of molecules containing the linkages is about 33,200 Da; a termite baiting composition wherein a maximum molecular weight of molecules containing the linkages is about 12,000 Da; a termite baiting composition wherein a maximum molecular weight of molecules containing the linkages is about 5,000 Da; etc.); a termite baiting composition comprising at least one fructan; a termite baiting composition comprising inulins (such as, e.g., a termite baiting composition wherein the inulins have a molecular weight in a range of about 3,000 to 5,000 Da; etc.); a termite baiting composition comprising levans (such as, e.g., a termite baiting composition wherein the levans have a molecular weight in a range of about 16,600 to 33,200 Da; etc.); a termite baiting composition wherein the termite food source comprises β-2→1 linkages linking D-fructofuranosyl units; a termite baiting composition wherein the termite food source comprises β-2→6 linkages linking D-fructofuranosyl units (such as, e.g., a termite baiting composition wherein the β-linked carbohydrate comprises at least one selected from the group consisting of: β-2→1-linked fructofuranosyl units or β-2→6-linked fructofuranosyl units, etc.); a termite baiting composition comprising a β-linked carbohydrate that is a cellulose-derived polymer (such as, e.g., a termite baiting composition that comprises a β-linked carbohydrate that consists of up to 75 hexose units; a termite baiting composition comprising a β-linked carbohydrate that has a molecular weight in a range of 1,000 to 12,600 daltons; a termite baiting composition wherein the β-linked carbohydrate is soluble or slightly soluble in water; a termite baiting composition that comprises at least one fructan (such as, e.g., inulins, levans, and fructofuranosides)); a termite baiting composition wherein the composition is coatable, or coated, on a wood material; a termite baiting composition including a ground-up grass containing β-2→6 fructofuranosides; a termite baiting composition including a ground-up grass embedded in a lignocellulosic material; a termite baiting composition including a plant, or a plant derivative, containing β-2→6 fructofuranosides (such as, e.g., a termite baiting composition wherein the plant or plant derivative is ground-up Jerusalem artichoke); etc.

The invention in another preferred embodiment provides a termite baiting composition, comprising at least one β-linked carbohydrate which is smaller than cellulose, in a form reachable and consumable by termites; such as, e.g., a termite baiting composition comprising at least one plant-derived β-linked hexose polymer; a termite baiting composition comprising at least one fructan; a termite baiting composition comprising inulins (such as, e.g., a termite baiting composition wherein the inulins have a molecular weight in a range of about 3,000 to 5,000 Da; etc.); a termite baiting composition comprising levans (such as, e.g., a termite baiting composition wherein the levans have a molecular weight in a range of about 16,600 to 33,200 Da; etc.); a termite baiting composition comprising β-2→1 linkages linking D-fructofuranosyl units; a termite baiting composition comprising β-2→6 linkages linking D-fructofuranosyl units (such as, e.g., a termite baiting composition wherein the β-linked carbohydrate comprises at least one selected from the group consisting of: β-2→1-linked fructofuranosyl units or β-2→6-linked fructofuranosyl units, etc.); a termite baiting composition comprising a β-linked carbohydrate that is a cellulose-derived polymer (such as, e.g., a termite baiting composition that comprises a β-linked carbohydrate that consists of up to 75 hexose units; a termite baiting composition comprising a β-linked carbohydrate that has a molecular weight in a range of 1,000 to 12,600 daltons; a termite baiting composition wherein the β-linked carbohydrate is soluble or slightly soluble in water; a termite baiting composition that comprises at least one fructan (such as, e.g., inulins, levans, and fructofuranosides)); a termite baiting composition wherein the composition is coatable, or coated, on a wood material; a termite baiting composition including a ground-up grass containing β-2→6 fructofuranosides; a termite baiting composition including a ground-up grass embedded in a lignocellulosic material; a termite baiting composition including a plant, or a plant derivative, containing β-2→6 fructofuranosides (such as, e.g., a termite baiting composition wherein the plant or plant derivative is ground-up Jerusalem artichoke); etc.

In another preferred embodiment, the invention provides a method of attracting termites, comprising: providing, in a first location (such as, e.g., a first location that is subterranean; a first location that is above ground), an amount of a composition comprising at least one β-2→1-linked carbohydrate which is smaller than cellulose, such as, e.g., termite attracting methods wherein one or more of the following occurs: (A) at least one termite feeds on the composition; (B) at least one termite after feeding on the composition departs the first location, and wherein subsequently further termites, after contact with the composition-consuming termite, come to the first location; (C) after a first termite feeds on the composition and departs the location, the first termite is in contact with additional termites who subsequently arrive at the first location; etc.

The invention also provides a preferred embodiment which is a method of attracting termites, comprising: providing, in a first location, an amount of a termite attractant which is a plant-derived β-linked carbohydrate which is not wood, decaying wood or cellulose.

The invention in a further preferred embodiment provides a termite baiting station, comprising: a composition comprising a β-linked carbohydrate which is smaller than cellulose, wherein the composition is disposed in a housing with at least one opening through which termites may travel to reach the composition (such as, e.g., a housing that is housing is compatible with subterranean placement; a housing that is compatible with above ground placement).

The invention in another preferred embodiment provides a termite baiting station, comprising: a housing with at least one opening through which termites may travel to reach a termite attractant housed therein; the termite attractant being a plant-derived β-linked carbohydrate which is not wood, decaying wood or cellulose.

In another preferred embodiment, the invention provides a termite attractant comprising: a composition which is eaten by termites at a faster rate and/or in larger amounts than the termites would eat any other of wood, decaying wood or cellulose; such as, e.g., a termite attractant including β-linked carbohydrate; a termite attractant including a β-linked carbohydrate that is a cellulose-derived polymer that is smaller than cellulose; a termite attractant including at least one inulin; etc.

### BRIEF SUMMARY OF THE DRAWINGS

FIG. 1 is a chemical formula for inulin, where n=20-30. Inulin is a fructan containing primarily β-2→1 linked fructosyl units

FIG. 2 is a chemical formula for a segment of a levan, where m=0-2. Levan(s are a fructan, containing primarily (in the backbone) β-2→6 linked fructosyl units.

### DETAILED DESCRIPTION OF A PREFERRED EMBODIMENT OF THE INVENTION

The present invention provides for baiting termites (especially, e.g., subterranean termites) by providing a bait system that out-competes other food resources available to the termites, such as, e.g., a bait system that contains the most attractive, best tasting food resource to subterranean termites in the area; a bait system (comprising bait stations) that causes subterranean termites to recruit to the bait stations in large numbers; a bait system that includes a chemical added to a termite monitor to enhance its attractiveness to foraging termites, etc.

Examples of termite food attractants that out-compete other food resources available to termites are, e.g., β-linked carbohydrates that are smaller than cellulose, such as, e.g. fructans (such as, e.g., inulins, levans, etc.); products produced from synthetically degraded cellulose; products produced naturally from degraded cellulose by soil inhabiting organisms (such as, for example, cellulose subjected to natural degradation in a laboratory with the degradation products harvested for use in termite baiting stations); cellulose derivatives that are easier for termites to digest than woody (lignocellulosic) materials; etc.

“Other food resources available to the termites” refers to any materials other than the bait and includes materials which are or would be eaten by termites in the absence of bait as well as materials which termites eat or would eat when bait is present. Examples of “other food resources available to the termites” are wooden building materials, decaying wood, etc.

In the absence of bait, naturally, the primary food source for subterranean termites is wood. Subterranean termites recycle woody materials, and hence play a significant role in the ecosystem. However, woody materials are, because of their chemical composition, difficult to degrade. The mixture that is wood is about 40 to 50% cellulose, with examples of the other components of the mixture that is wood being lignin, resins, sugars, a variable amount of water and potassium compounds. The cellulose in wood consists of β-linked polymers of glucose and lignins. These polymers form complex organic matrices that are relatively difficult for organisms to digest.

“Cellulose” refers herein to high molecular weight, linear polysaccharides made up of D-glucopyranose units linked β-1→4. (See Formula 1 above for the cellulose chain, where n=2,000 to 10,000.)

“β-linking” herein means the attachment of a chemical unit to the side chain of a ring-configured compound. Examples of “β-linking” are, e.g., β-1→4 linking of anhydroglucose units in cellulose; β-1→4 linking of D-glucopyranose units in linear polysaccharides; β-2→1 linking of D-fructofuranosyl units in fructofuranosides; β-2→6 linking of D-fructofuranosyl units in fructofuranosides; etc., with the preceding being examples and not an exhaustive list of β-linking.

For use in the present invention in termite baiting, molecules smaller than cellulose containing β-linking of the β-2→6 kind and molecules smaller than cellulose containing β-linking of the β-2→1 kind are preferred. Fructans (such as, e.g., inulins, levans, etc.) are preferred examples of smaller-than-cellulose molecules containing β-2→6 and/or β-2→1 β-linking.

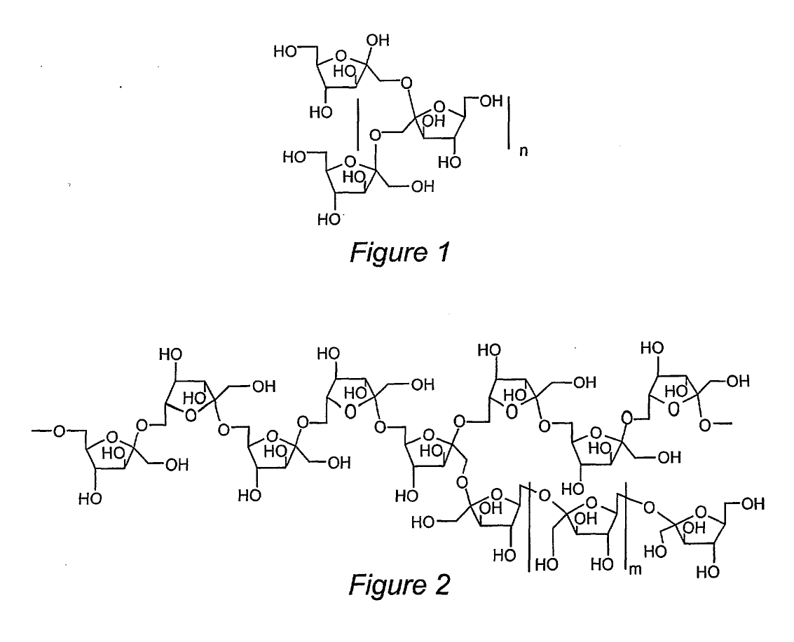

Fructans may contain linkage types β-2→1, β-2→6 and β-2→1→6 branching points in any combination. Preferred examples of fructans include, e.g., inulin (see FIG. 1) and levan (also referred to as “levans”) (see FIG. 2).

“Smaller than cellulose” molecules refer to molecules which have lower molecular weight than 150,000 daltons, which is lower than the lowest molecular weight naturally-occurring cellulose (which has molecular weight about 160,000 daltons).

Examples of a termite attractant for use as termite bait are, e.g.: a water soluble polymer formed by a termite's digestion of cellulose; a molecule less complex than cellulose which is more easily digestible by the termite microbial system; fructans (such as, e.g., inulins (most preferably inulins in a molecular weight range of 3,000 to 5,000 Da); levans (most preferably levans in a molecular weight range of 16,600 to 33,200 Da); β-linked D-fructofuranosyl fructans; fructofuranosides (most preferably fructofuranosides having molecular weight up to 12,000 Da and composed of D-fructofuranosyl units linked β-2→1 or fructofuranosides composed of D-fructofuranosyl units linked β-2→6); etc.); plant-derived β-linked hexose polymers (such as fructans); less complex molecules than those found in natural woody materials and digestible more easily by the termite microbial system; etc.

A preferred example of a termite attractant is inulin, which refers to a compound of approximately 35 β-2→1 linked fructosfuranosyl units, of molecular weight 5,880 daltons. Inulin is a widespread β-linked carbohydrate which is present in more than 30,000 plant species.

Inulins and levans, which have been mentioned for use in the invention as termite bait (especially for baiting subterranean termites) are fructans, which are synthesized in plants (primarily grasses) or produced extracellularly by some bacteria. However, the present invention is not limited to compounds that have been produced by synthesis in plants or by bacteria. Compounds that have been synthetically produced or gathered from other natural production processes also may be suitable termite feeding attractants within the present invention, when they are preferred by termites (especially subterranean termites) to competing food resources such as wood.

Inulins are polysaccharides comprised of D-fructofuranosyl units linked β-2→1. Inulins are found in the roots and tubers of plants in the family Compositae where they function as reserve polysaccharides. Inulins are relatively low molecular weight molecules, ranging from 20 to 30 D-fructofuranosyl units (3,000 to 5,000 Da).

Levans are polysaccharides comprised of fructofuranosyl units linked β-2→6, and are found primarily in grasses. The levans have molecular weights of about 100 to 200 fructofuranosyl units (16,800-32,000 Da).

Inulins and levans are not easily degraded by many organisms. (Inulin has even been used in human food as a fiber additive (also as a sugar substitute, fat replacer, or texturing agent) and classified as non-digestible oligosaccharides.) This indigestibility of fructans to many organisms makes the fructans particularly preferred for use in subterranean termite baiting, because their relative nondegradability by other organisms may give them increased longevity in the soil (such as in an in-ground termite bait station) when compared to other termite consumption enhancing (sugar-like) compounds (which can be consumed by other organisms besides just termites).

An example of making termite bait according to the present invention is to obtain inulins, levans or other fructans from a natural plant material (such as, e.g., Jerusalem artichokes, prairie grasses, other fructan-containing grasses, etc.), such as by grinding the plant material, followed by embedding the ground plant material in a lignocellulosic material which is incorporated into a termite bait matrix (such as incorporation into a conventional white pine termite bait matrix).

In a preferred example of using the invention, an inventive termite feeding attractant (such as β-fructofuranoside polymers (e.g., inulin, etc.)) are added to a termite feeding matrix, and subterranean termites do one or both (preferably both) of the following: feed preferentially on the bait matrix with the inventive feeding attractant rather than on other local food resources; recruit additional termites to bait stations containing the inventive termite feeding attractant.

It will be appreciated that the present invention provides a termite feeding attractant and/or a termite feeding stimulant which may be used in combination with a variety of termite control methods. The invention may be used to manipulate termite behavior (especially behavior of subterranean termites) as desired, such as, e.g., to manipulate termite behavior to protect structures from termite damage by providing a more attractive food source; etc. The present invention solves the problem of competing food resources (natural or structural wood) decreasing termite bait consumption. The present invention may be used to provide an inventive termite attractant (such as, e.g., inulins, levans, other beta-fructofuranoside polymers, etc.) that serve as a food additive/attractant added to a termite bait matrix (such as a conventional termite bait matrix). The inventive consumption enhancing compounds may be used to make the bait more palatable to the termites than competing food resources, so that termites feed on these baits, according to the invention, preferentially relative to the other food resources (such as consuming more of the bait than the other food resources).

In a subterranean termite baiting station according to the invention, maximizing the amount of the termite attractant is generally preferred. When using an inventive termite attractant comprising smaller-than-cellulose molecules having beta-linkages (such as, e.g., β-2→6 or β-2→1 linkages), at least an amount of about 0.05% is suggested for a termite baiting station of a size about 3.5 mm×16 mm.

In termite baiting according to the invention, the inventive termite attractant (such as inulins, etc.) may be used alone or in combination with at least one other material, such as, for example, a toxicant, a termiticide, etc.

Examples of termites against which the inventive baiting methods may be used are, e.g., subterranean termites, such as Reticulitermes flavipes, Reticulitermes virginicus, Reticulitermes hesperus, Coptotermes formosanus, etc. The inventive baiting methods are preferably used against subterranean termites.

Subterranean uses have been particularly mentioned for practicing the invention. However, the invention may also be practiced above-ground, such as by placing above ground termite bait stations.

The following inventive Examples are mentioned for illustrating and appreciating the invention, but it will be appreciated that the invention is not limited to the Examples.

### EXAMPLE 1

Summary

Hexaflumuron is known as a pesticide used in some insect baits. An experiment was designed to determine if termite consumption of 0.5% hexaflumuron bait would be reduced in the presence of competing food resources. Hungry termites were given a choice between a diet of paper containing 0.5% hexaflumuron versus a diet containing no hexaflumuron. Because individual termites eat very little material, measurement of very small amounts of material would be needed. One of the most sensitive methods available for measuring such very small amounts of chemicals (molecules) is the use of radioisotopes (radioactive materials). The present inventors opted to use a radioactive form of hexaflumuron (a molecule labeled with radioactive carbon, ¹⁴C) for the 0.5% hexaflumuron diet.

The control (blank diet) was paper onto which was added a very small amount of radioactive inulin (tritiated, ³H). Inulin was selected for its similarities to cellulose and as a good marker for measuring the amount of control diet from which termites would have an opportunity to choose, because of availability of an instrument that can distinguish between ¹⁴C and ³H.

In doing the series of choice versus no-choice experiments, the present inventors observed that consumption of 0.5% hexaflumuron diets were significantly reduced in the presence of competing food resources.

In addition, the present inventors found that termites preferred (i.e., were attracted to) diets containing the very small amount of inulin. Thus, inulin was discovered to act as a food attractant for termites, which was an unexpected and highly advantageous result. This was a surprising discovery, and led to the present inventive recognition of the usefulness of inulin and other small β-2→1-linked cellulose-like compounds as termite bait.

### Detailed Summary of Effects of Competing Food Sources on Subterranean Termite, Reticulitermes spp. (Isoptera: Rhinotermitidae), Consumption of Hexaflumuron Treated Baits in Laboratory Assays

Subterranean termite consumption of ¹⁴C-hexaflumuron treated baits was compared in laboratory no-choice and choice tests. In no-choice tests groups of 100 termite workers consumed an average of 3 mg of ¹⁴C-hexaflumuron bait in 2 days and 11.4 mg in 5 days. Termite consumption of ¹⁴C-hexaflumuron bait was reduced in the presence of a competing food resource. At 5 days consumption of the ¹⁴C-hexaflumuron bait was significantly reduced to only 0.2 mg in the presence of a ³H-inulin treated food resource. Consumption comparisons of competing food resources in the choice tests were made to determine termite preference for particular food resources. In choice tests comparing ¹⁴C-hexaflumuron and ³H-inulin treated bait, consumption of the inulin bait was significantly greater (6.0 mg) than the hexaflumuron (0.2 mg) at 5 days, indicating a preference for the inulin treated bait.

Quantification of radioactive isotopes from individual termites was used to determine how much a single termite consumed of ¹⁴C-hexaflumuron diet in the presence of a competing food source. Individual termite consumption reflected the population consumption results. ¹⁴C-hexaflumuron consumption was significantly reduced from 56.9 μg in the no-choice test to only 19.3 μg in the presence of the control diet at 5 days. ¹⁴C-hexaflumuron consumption by individual termites was also significantly decreased when the diet was offered in the presence of a ³H-inulin food resource. The reduction of ¹⁴C-hexaflumuron consumption in the presence of ³H-inulin at 5 days, dropped from 56.9 μg in the no-choice test to only 2.3 μg in the choice test. Consumption comparisons of ¹⁴C-hexaflumuron and ³H-inulin in the choice tests indicated a significant preference for the inulin treated bait.

### Methods and Materials

Subterranean Termite Collection. Five wild populations of Reticulitermes spp. were collected from fallen wood in forested areas of Fairfax County (N38° 43.29′ and W77° 30.93′), Montgomery County (N37° 12.46′ and W80° 24.47′), Rockbridge County (N37° 48.00′ and W 79° 25.00′), and Roanoke County (N37° 19.53′ and W79° 58.53′), Virginia. Termites were harvested by placing the infested wood into large storage bins (70 L; Sterlite®; Sterlite Corporation, Townsend, Mass.) on top of damp, recycled paper towels (Acclaim®; Fort James Corporation, Deerfield, Ill.). As the wood dried out the termites moved into the moist paper towels. The infested paper towels were then transferred to plastic storage containers (11.3 L; Rubbermaid, Wooster, Ohio) containing vermiculite (500 g; moistened 150% by weight (Lenz M., T. L. Amburgey, D. Zi-Rong, H. Kuhne, J. K. Mauldin, A. F. Preston, and M. Westcott, 1987, Interlaboratory studies on termite-wood decay fungi associations: I. Determination of maintenance conditions for several species of termites (Isoptera: Mastotermitidae, Termopsidae, Rhinotermitidae), Sociobiology, 13:1-56; Cherokee Vermiculite Horticultural Fine Cherokee Products, Jefferson City, Tenn.). Subterannean termite containers were stored in complete darkness (˜21° C. and 97% RH) until needed for testing. Subterranean termites were tested within one month after being collected from the field.

Termite Diet Preparation. Recycled brown paper toweling (Acclaim®) was cut into squares (35×35 mm) and used as a diet substrate. The diet substrates were placed into glass Pyrex Petri dishes (100×20 mm; Corning Glass Works, Corning, N.Y.) and dried overnight in a single wall, gravity convection, laboratory oven (60° C.; Blue M SW-17TA; Blue M Electric Company; Blue Island, Ill.). After 24 hours, each diet substrate was taken out of the oven, numbered in the corner with a pencil and weighed on a balance (Mettler AE163; Lab Tech, Inc.) to the nearest 0.1 mg. After weighing, certain diets were treated with radiochemicals. Because hexaflumuron cannot be stored at temperatures greater than 50° C., radioisotopes were only applied after the diets were oven dried. The weight of the isotopes on the diet after air drying was determined to be negligible.

Radiolabeled Chemicals and Visual Markers. Radioisotopes, ¹⁴C-hexaflumuron and ³H-inulin, technical grade hexaflumuron (non-radiolabeled), and Nile Blue-A (visual marker) were formulated for application to termite diet substrates. Radiolabels were used to quantify the effects of competing food sources on hexaflumuron consumption. Hexaflumuron-dichlorophenyl-UL-[¹⁴C] (lot F0662-54, specific activity of 21.5 mCi/mmol) was obtained from the radiosynthesis group at Dow AgroSciences (Indianapolis, Ind.). Radiochemical purity of the hexaflumuron had been determined by the manufacturer to be 98.7%. Nonradiolabeled, technical-grade hexaflumuron (98% pure) was also obtained from chemical resource services at Dow AgroSciences (lot#17/95; Indianapolis, Ind.). Inulin-methoxy, [methoxy-³H-] (lot 2978-124, specific activity 200 mCi/g) was purchased from the radiosynthesis group at the DuPont Company (Wilmington, Del.). Radiochemical purity of the inulin had been determined by the manufacturer to be 98.7% using high pressure liquid chromatography.

Inulin was used as an alternate control diet treatment to compete with hexaflumuron. Nile Blue-A (Allied Chemical Company, Morristown, N.J.) was selected as the visual marker because of its long-term visibility and low associated mortality for Reticulitermes flavipes (Haagsma, K. A. and M. K. Rust, 1993, Two marking dyes useful for monitoring field populations of Reticulitermes Hesperus (Isoptera: Rhinotermitidae), Sociobiology, 23: 115-16; Oi, F. M. and N.-Y. Su, 1994, Stains tested for marking Reticulitermes flavipes and R. virginicus (Isoptera: Rhinotermitidae), Sociobiology, 24:241-257; Su, N.-Y., P. M. Ban, and R. H. Scheffrahn, 1991, Evaluation of twelve dye markers for population studies of the eastern and Formosan subterranean termite (Isoptera: Rhinotermitidae), Sociobiology, 19: 349-362; King, J. E., 2000, Laboratory feeding response of Reticulitermes Flavipes (Kollar) (Isoptera: Rhinotermitidae) to dyed filter paper in no-choice and choice feeding tests, Sociobiology, 36:169-179; Suarez, M. E. and B. L. Thorne, 2000, Rate, amount, and distribution pattern of alimentary fluid transfer via trophallaxis in three species of termites (Isoptera: Rhinotermitidea, Termopsidae), Ann. Entomol. Soc. Am., 93: 145-155). The purpose of the dye was to ensure that termites were feeding on the diets. Termites that fed on the experimental diets were dyed a bright blue color.

Diet Treatments

Control Diets. Control diets were treated with the visual marker only. The visual marker was formulated by dissolving Nile Blue-A in acetone and applying a 150 μl aliquot of dye solution to each diet substrate. The final Nile Blue-A concentration on the diet was 0.1%.

¹⁴C-hexaflumuron Diets. A stock solution of technical grade hexaflumuron, ¹⁴C-hexaflumuron (0.5% total hexaflumuron concentration) and 0.1% Nile Blue-A was formulated in acetone. An aliquot (150 μl) of the solution was applied to each diet substrate so that each diet contained 0.27 μCi of the ¹⁴C-hexaflumuron.

³H-inulin Diets. A stock solution of the ³H-inulin and 0.1% Nile Blue-A (1.95 mg) was formulated in acetone. An aliquot (150 μl) of the solution was applied to each diet substrate so that each diet contained 2.05 Ci of the ³H-inulin. ³H has a lower energy spectrum than ¹⁴C, so ˜8× more ³H-inulin was added to the diets than ¹⁴C-hexaflumuron to facilitate radioisotope quantification process after termite consumption.

Sand Preparation. Approximately 4 L of play sand (Quikcrete®, Quikcrete Companies, Atlanta, Ga.) was washed with tap water 4 times to remove impurities. Washed sand was dried for 48 hours in a single wall gravity convection laboratory oven (270° C.; Telco®; Precision PS Scientific, Chicago, Ill.) prior to use. The dried sand was then placed in a plastic storage bag (3.79 L; Target Corporation, Minneapolis, Minn.) and moistened with distilled water (15% by weight of the sand). Moistened sand was then kneaded by hand in the storage bag and stored for at least 24 hours to ensure even distribution of moisture. Sand was stored in the plastic bag until needed for testing.

Bioassay Arenas: Consumption bioassays were performed in choice and non-choice bioassay arenas. Arena tests were used to evaluate termite consumption of hexaflumuron treated bait alone and in the presence of a competing food source.

No-Choice Bioassay. No-choice bioassay arenas were assembled by connecting two Petri dishes with Tygon tubing (inner diameter 3.2 mm, outer diameter 6.4 mm). Petri dishes were washed 4 times in tap water to eliminate static electricity. Tygon tubing was soaked in tap water for 3 hours and allowed to air dry prior to use. One Petri dish (95 mm×15 mm; Fisher Scientific) served as a termite housing chamber and was filled with moist sand (˜45 g). A second, smaller Petri dish (60 mm×15 mm; Fisher Scientific) served as a diet chamber. Termites placed in the no-choice arenas would forage from the housing chamber through the tubing to the diet chamber.

Choice Bioassay. Choice arenas were similar to the no-choice arenas with the exception that the housing chambers were attached to smaller two diet chambers (60 mm×15 mm), each containing a different diet. Thus, termites placed inside choice arenas choice simultaneously forage on two diets at once. Choice bioassays were set up in each of the following diet combinations: ¹⁴C-hexaflumuron and control, ³H-inulin and control, and ¹⁴C-hexaflumuron and ³H-inulin.

Bioassay Design. Prior to testing, 100 worker termites (at least 3^{rd} instar) were aspirated out of the storage containers and transferred into the housing chamber of one experimental arena. Termites were allowed to acclimate to the arena and forage on untreated paper towel for 72 hours. After the acclimation period, paper towel was removed, and all clinging termites were gently tapped back into diet chamber. Experimental diets were then placed into the diet chambers.

For uniformity, all diets were secured in the Petri dishes. However, securing the diets was intended to minimize radioactive contamination of the arenas in tests using radiochemicals. Diets were secured by placing them on top of a glass coverslip (Rect. No. 1 22×30 cm; Corning Labware and Equipment) inside the diet chamber and putting ⅓ of a standard paper clip on top of them. A magnet (19.05 mm Diameter; ProMag®, Marietta, Ohio) was placed underneath the bottom of the Petri dish holding the diet between the paper clip and the magnet. Three pieces of masking tape were put on the outside of the arena to seal the housing chamber lid.

Bioassay arenas were set up for each of the five treatment groups: 2 no-choice tests, either control or hexaflumuron, and 3 choice tests, hexaflumuron and a control, inulin and a control, or hexaflumuron and inulin. Each treatment was further subdivided into two test periods: 2 d and 5 d. Each test day within a treatment was replicated five times for a total of 50 arenas, 20 no-choice and 30 choice. Each replicate within a treatment/day contained termites from a different field population. Once the data from an arena had been recorded on a particular test day, the arena was removed from the test.

Humidity Chamber. All bioassay arenas were placed inside humidity chambers, which were constructed by pouring play sand into the bottom of a plastic storage container (11.3 L; Rubbermaid, Wooster, Ohio) to a depth of 4.5 cm. Tap water was poured over the sand to the point of saturation. Any standing water was absorbed with paper towels. A sheet of aluminum foil (Super Foil™; Atlantic Paper & Foil Corporation, Hauppauge, N.Y.) was laid down to cover the saturated sand. Arenas containing termites were placed inside plastic storage bags (3.8 L; Target Corporation, Minneapolis, Minn.) and set on top of the aluminum foil in the chamber. The top of the plastic bag was rolled down to allow for air circulation. Plastic bags were used to separate the arenas from each other and to catch escaped termites. Escaped termites were returned to their respective experimental areas. Humidity chambers were closed with snap top lids and were placed in total darkness in a cabinet (˜21° C. and 97% RH) for the duration of the experiment.

Recording Mortality. Termite mortality was recorded to ensure that the test insects were vigorous (Sheets et al. 2000), and that excessive mortality did not influence consumption data. Termites that did not seem to exhibit proper molting were considered moribund and were added to the mortality count (Su, N.-Y. and R. H. Scheffrahn, 1993, Laboratory evaluation of two chitin synthesis inhibitors, hexaflumuron and diflubenzuron, as bait toxicants against Formosan and eastern subterranean termites (Isoptera: Rhinotermitidae), J. Econ. Entomol., 86:1453-1457).

Diet Consumption by Groups of Termites. After termite mortality was recorded for each bioassay, all partially consumed diets (no choice and choice) were removed from the arenas and oven dried for 24 h. Diets were then weighed again to calculate consumption. Post-test weights of partially consumed diets were subtracted from the initial diet weights to determine total consumption by treatment.

Diet Consumption by Individual Termites. After mortality was recorded for a particular treatment/day, 20 surviving termites were randomly selected from each radioactive treatment arena for isotope analysis. Random selection was not limited to dyed termites. Non-dyed termites were also selected. The termites were thoroughly rinsed with distilled water three times to remove any radioactivity from the outside of the body. They were next placed on paper towels to remove excess water. Each rinsed, dried termite was placed into a separate microcentrifuge tube (1.5 ml; Fisher Brand), and the body was homogenized in 200 μl of distilled water. The homogenate was transferred into a glass scintillation vial (20 ml; Kimble Glass, Vineland, N.J.). Microcentrifuge tubes were rinsed three times with 200 μl of distilled water per rinse. Each rinse was added to the homogenate in the scintillation vial. An aliquot of scintillation cocktail (8 ml; Scintiverse® BD; Fisher Scientific, Fair Lawn, N.J.) was then added to each vial.

The amount of radioactivity contained within each sample was quantified by using a scintillation counter (Beckman Coulter, Inc.™ LS 6500, Fullerton, Calif.). The individual termite samples contained very low dpm counts. Therefore, sample vials containing only a single isotope (from no-choice tests) were counted for 10 minutes. However, sample vials that potentially could contain dual isotopes (from choice-tests) were counted for 20 minutes to improve the accuracy of the counts.

Background Radioactivity Measurements. After termite mortality had been recorded, 2 termites were selected at random from each no-choice, control arena. These termites were rinsed, homogenized, and prepared for scintillation counting as previously described. Control termites were counted in the scintillation counter for 10 minutes to record background radioactivity. Background radioactivity was measured for each treatment group (choice and no-choice) at both 2 d and 5 d. Background measurements also accounted for any quenching that occurred due to the termite body fragments occluding light transmission in the scintillation counter. Before the test data was analyzed, background radioactivity counts for a particular sample was subtracted from the sample's spectral peak (Traniello, J. F. A., R. B. Rosengaus and C. K. Levy, 1985, Single and double isotope labeling of social insect colonies, Entomol. Exp. Appl., 38:87-92; Suarez, M. E. and B. L. Thorne, 2000, Effects of food type and foraging distance on trophallaxis in the subterranean termite Reticulitermes virginicus (Isoptera: Rhinotermitidae), Sociobiology, 35: 487-498).

Radiolabel Counting using Dual Label Technique. Specialized procedures were required for analysis of radiolabeled samples containing both ¹⁴C and ³H. Due to the potential low/high counts and spillover of ¹⁴C and ³H in the counting window, a series of dilutions was made from extracted diets (with known amounts of activity) to correct for spillover. The range of activity values for ¹⁴C and ³H and a combination of the two isotopes within the samples was determined. Spillover correction curves were generated for the range of sample data and used to correct those samples where high levels of both ¹⁴C and ³H occurred and spillover was evident.

Statistical Analysis. Bioassays were arranged in a 5 (treatment) by 2 (day) factorial, randomized complete block design (RCBD, SAS Institute, 1999, SAS/STAT User's Guide, Version 8, SAS Institute, Cary, N.C.). The data was blocked by termite field population to account for within treatment variability due to differential feeding between colonies.

The mean percentage of termite mortality (to assure termite vigor) between the 5 bioassay treatments was analyzed separately for tests run for 2 d and 5 d. Mortality was compared using analysis of variance (ANOVA, SAS Institute 1999). Values of P≦0.05 were used to indicate significance.

Comparisons of termite diet consumption (mg) between treatments were analyzed separately at 2 d and 5 d using ANOVA. The model for the ANOVA used termite colony and treatment as sources of variation.

Mean consumption of the hexaflumuron diet in the no-choice tests was compared with the mean amount of hexaflumuron diet consumed in the presence of a competing food source (choice tests: hexaflumuron and control or hexaflumuron and inulin) using the Student's t-test for both 2 and 5 days respectively (SAS Institute 1999).

Mean consumption of the inulin diet in choice tests, inulin and control or inulin and hexaflumuron, was compared using ANOVA. The model for the ANOVA used the colony and treatment as sources of variation.

Finally, mean consumption of the two diets within each of the three choice tests was analyzed to determine whether termites preferred one diet over another. Due to the binomial nature of the choice test design, diet consumption was analyzed using a Student's t-test for μ=0.50 (SAS Institute 1999). For all consumption tests values of P≦0.05 were used to indicate significance.

Quantification of radioactive isotopes from individual termite cadavers was used to determine how much a single termite consumed of ¹⁴C-hexaflumuron diet in the presence of a competing food source. Mean consumption of ¹⁴C-hexaflumuron diet in the no-choice test was compare with ¹⁴C-hexaflumuron consumption in the choice test using GLM ANOVA with Least Squares adjustment for multiple comparisons of mean values. For all tests data was analyzed separately for 2 d and 5 d.

Although the ³H-inulin had been provided simply as a food source alternative to the hexaflumuron treated bait, termite consumption of the ³H-inulin diet was surprisingly high by comparison. Therefore, as a point of interest, the mean consumption of ³H-inulin diet in the two choice tests, ¹⁴C-hexaflumuron and ³H-inulin, and ³H-inulin and control, were compared using GLM ANOVA (SAS Institute 1999).

Finally, mean consumption of the two radioisotopes, ¹⁴C-hexaflumuron and ³H-inulin, in the choice tests were compared to determine whether termites preferred one diet over another. Mean consumption was analyzed using a Student's t-test for μ=0.50 (SAS Institute 1999). Because termites that did not contain the visual marker were used in the radioisotope consumption analysis as well as those that did, variability in the consumption data was relatively high This variability among termites in the field would be expected to be even more pronounced. Therefore, values of P≦0.1 were used to indicate significance for all consumption studies evaluating individual termites.

### Results

Mortality. Subterranean termite mortality was low across all treatments with an average of less than 3% at 5 d. Mortality was not significantly different between any of the treatments at 2 d (P=0.598) or 5 d (P=0.974).

Diet Consumption by Termite Populations. Mean consumption (mg) by the subterranean termite populations was not significantly different for any of the treatment groups, either choice or no-choice at 2 d (P=0.714). Overall, at 2 d termites ate the same amount (˜3 mg) in the individual no-choice arenas as they did in the choice tests where consumption of the two diets was quantified together. As expected, the termites had eaten considerably more diet by 5 d, however, consumption of diets between the treatment groups was still not significantly different (˜11 mg; P=0.148).

To determine the impact of competing food sources on hexaflumuron consumption, the quantity of the hexaflumuron diet consumed in the no-choice tests was compared with the quantity of diet consumed in the choice tests, where the hexaflumuron was competing with either a control diet or an inulin treated diet (Table A). Mean consumption of hexaflumuron in the no-choice tests was 3.0 mg at 2 d. In the choice tests where the hexaflumuron diet was offered with the control diet, consumption of the hexaflumuron diet was reduced to 1.6 mg at 2 d. This reduction was not significant (P=0.170). When the inulin diet was offered as a competing food source, the hexaflumuron diet consumption was reduced to 1.0 mg at 2 d. This reduction was also not significant (P=0.068). At 5 d consumption of hexaflumuron in the no-choice test was 11.4 mg. In choice tests where the hexaflumuron diet was competing with the control diet termite consumption of hexaflumuron was reduced to 3.2 mg (P=0.080). This reduction was not significant. However, in the choice test where the inulin diet was competing with the hexaflumuron diet, consumption of hexaflumuron was significantly reduced to only 0.2 mg at 5 d (P=0.045).

TABLE A
Comparison of hexaflumuron consumption (mg)
by termite populations in choice and no-choice tests at 2 d and 5 d.

| | | | | | |
|---|---|---|---|---|---|
| | | | Hexaflumuron | | |
| | | | Consumption | | |
| | | | (mg) | | P- |
| Test | Diet | n | (Mean ± SEM) | t-statistic | value |

DAY 2

| | | | | | |
|---|---|---|---|---|---|
| No-choice | Hexaflumuron | 5 | 3.0 ± 0.7a | 2.80 | 0.170¹ |
| Choice | Hexaflumuron | 5 | 1.6 ± 0.9a | | |
| Choice² | Control | 5 | 2.2 ± 0.8 | | |
| No-choice | Hexaflumuron | 5 | 3.0 ± 0.7a | 6.18 | 0.068 |
| Choice | Hexaflumuron | 5 | 1.0 ± 0.8a | | |
| Choice | Inulin | 5 | 2.0 ± 0.6 | | |

DAY 5

| | | | | | |
|---|---|---|---|---|---|
| No-choice | Hexaflumuron | 5 | 11.4 ± 3.9a | 5.44 | 0.080 |
| Choice | Hexaflumuron | 5 | 3.2 ± 1.4a | | |
| Choice² | Control | 5 | 6.4 ± 3.8 | | |
| No-choice | Hexaflumuron | 5 | 11.4 ± 3.9a | 8.32 | 0.045 |
| Choice | Hexaflumuron | 5 | 0.2 ± 0.1b | | |
| Choice | Inulin | 5 | 6.0 ± 1.3 | | |

¹Student's t-test (SAS Institute 1999). Means followed by different letters are significantly different (P ≦ 0.05).
²Italics denotes consumption of competing diet. However, consumption of competing diet in choice test was not included in the statistical analysis.

Finally, paired comparisons of diet consumption within the three choice tests were made to determine if the termite populations preferred one diet over another. Preference was defined as the consumption of one diet in the choice test being significantly greater than 50% of total consumption. At 2 d, termite diet consumption indicated no feeding preferences for either diet offered in any of the choice tests. However, at 5 d a preference for the inulin diet was indicated in one of the choice tests. (Table B) Termites consumed significantly more of the inulin diet (6.0 mg; P<0.0001) than the hexaflumuron diet (0.2 mg) at 5 d.

TABLE B
Day 5

| Competing | Consumption (mg) | | |
|---|---|---|---|
| Diets | (Mean ± SEM) | t-statistic | P-value |
| Hexaflumuron | 0.2 ± 0.1 a | −20.647 | <0.0001 |
| Inulin | 6.0 ± 1.3 b | | |

Students' t-test for μ = 0.5 (SAS Institute 1999)
Values of P < 0.05 were used to indicate significance

Referring to Table B, inulin-treated bait (invention) is compared to hexaflumuron treated bait. Hexaflumuron is the active ingredient in the Sentricon Termite Elimination System™. The subterranean termites ate thirty (30) times as much of the inulin treated bait as the Hexaflumuron treated bait.

Diet Consumption by Individual Termites. When the average ¹⁴C-hexaflumuron consumption by an individual termite was compared in no-choice and choice tests the differences were significant (F=7.76, df=1, P=0.017). At 2 d ¹⁴C-hexaflumuron consumption was significantly reduced from 38.9 μg in the no-choice test to only 14.5 μg in the choice tests where ¹⁴C-hexaflumuron was competing with the control diet (P=0.090). Similarly at 5 d, ¹⁴C-hexaflumuron consumption was significantly reduced from 56.9 μg in the no-choice test to only 19.3 μg in the presence of the control diet (P=0.058).

Like the control choice tests, consumption of ¹⁴C-hexaflumuron by individual termites was significantly decreased when the diet was offered in the presence of a 3^{H}-inulin food resource (F=48.89, df=1, P<0.0001). At 2 d ¹⁴C-hexaflumuron consumption was significantly reduced from 38.9 μg in the no-choice test to only 7.3 μg when competing with the ³H-inulin diet (P=0.0001). The reduction of ¹⁴C-hexaflumuron consumption in the presence of ³H-inulin was even more pronounced at 5 d, where consumption was dropped from 56.9 μg in the no-choice test to only 2.3 μg in the choice test (P<0.0001).

Finally, the consumption of the ¹⁴C-hexaflumuron and ³H-inulin were compared in the choice test to determine if single termites preferred one diet over the other. At 2 d the consumption data indicated that the termites consumed some of both diets but did not prefer either diet (P=0.285). However, by 5 d termite consumption indicated a significant preference for ³H-inulin (P=0.002). On average, individual termites consumed 19.4 μg of ³H-inulin diet and only 2.3 μg of ¹⁴C-hexaflumuron diet.

Termite mortality in this study was less than 3% for all treatment groups. Therefore, handling and disease did not negatively impact the termite populations or reduce consumption in any of the treatment groups. In addition, previous studies determined that the LT₅₀ for subterranean termites fed hexaflumuron bait was ˜26.6 d and that the onset of toxicity does not occur until approximately 15 d (Sheets et al. 2000). The 5 day duration of the consumption experiments described here fall well short of the expected onset of hexaflumuron toxicity. Termite mortality was not significantly different between any of the treatment groups, those that contained radioisotopes and those that did not. Therefore, it can be concluded that differences in consumption between the treatment groups were not influenced by mortality or morbidity due to any danger inherent in the research design.

The mean termite consumption across the five colonies in this Example 1 was approximately the same for all treatments (hexaflumuron diet, control diet, inulin diet, or some combination) at 2 d and at 5 d.

In the choice tests where consumption of both diets offered were compared to see if there was a preference, the termites significantly preferred to consume the inulin over the hexaflumuron diet. This result had not been expected.

Radiolabels have been used successfully to study the metabolism of bait system toxicants within individuals and populations of termites. Radiolabels have been used to study trophallaxis (Alibert, J., 1959, Les echanges trophallactiques chez le termite a cou jaune (Calotermes flavicolis Fabr.) etudies a l'aide du phosphore radioactive, C.R. Acad. Sc. Paris, 248: 1040-1042; Gosswald, K. and W. Kolft, 1963, Tracer experiments on food exchange in ants and termites, Proc. Symp. Radiation Radioisotopes Appl. Insects of Agric. Importance: 25-42; Afzal, M. 1983, Radioisotope studies of trophallaxis in the drywood termite Bifiditermes beesoni (Gardner) (Isoptera). I. Effect of group size on the rate of food exchange, Mater. Org. (Berlin) 18:51-64; Afzal, M., 1984, Radioisotope studies of trophallaxis in the drywood termite Bifiditermes beesoni (Gardner) (Isoptera). III. Feeding and Excretory differences among grouped and isolated colony members, Mater. Org. (Berlin) 19: 55-67; Traniello et al. 1985; Rosengaus, R. B., J. F. A. Traniello, and C. K. Levy, 1986, Social transfer, elimination, and biological half-live of gamma-emitting radionuclides in the termite Reticulitermes flavipes (Kollar), J. Appl. Entomol, 101: 287-294; Suarez and Thorne 2000b), foraging patterns (Easey, J. F., Detection of termite infestation. Miscellaneous reports of the Australian Atomic Energy Commission, Lucas Heights, N. S. W., Australia, 1981), and feeding behaviors in termites (Gosswald 1962; McMahan, E. A., 1962, Laboratory studies of colony establishment and development in Cryptotermes brevis (Walker) (Isoptera: Kalotermitidae), Proc. Hawaiian Entomol. Soc., 18:145-153; McMahan, E. A., 1963, A study of termite feeding relationships, using radioisotopes, Ann. Entomol. Soc. Am., 65: 74-82; McMahan, E. A., 1966, Food transmission within the Cryptotermes brevis colony (Isoptera: Kalotermitidae), Ann. Entomol. Soc. Am., 59:1131-1137). Sheets et al. (2000) used radiolabels to determine the rate of uptake, clearance, insect-to-insect transfer, and metabolism of ¹⁴C-hexaflumuron in R. flavipes. In the consumption evaluation of this Example 1, the use of the radiolabeled diets allowed comparison of the consumption behavior of an individual termite worker to that of the test population.

The quantification of radiolabels within individual termites determined that individual consumption was a good indicator of how the population fed as a whole. Similar to the tests evaluating population consumption, the average termite sampled in a ¹⁴C-hexaflumuron choice test contained less of the ¹⁴C-radiolabel than a termite sampled from a no-choice test. Likewise, the individual termite consumption in the dual labeled choice test, ¹⁴C-hexaflumuron and ³H-inulin, further indicated that when given a choice, an individual termite consumed less of the ¹⁴C-hexaflumuron than it did when there was no competing food resource. Also, consumption analysis in the dual label choice test indicated that the individual termites had fed on both the ¹⁴C-hexaflumuron and ³H-inulin diets. However, a comparison of the amount of each diet consumed indicated that, like the population as a whole, individual termites preferred to consume the ³H-inulin diet. We observed that if the population consumed both diets but preferred to consume one diet over the other, individual termites exhibited the same diet preference in this Example 1.

In the field, subterranean termites are known to feed from multiple food resources (Grace, J. K., and N.-Y. Su, 2001, Evidence supporting the use of termite baiting systems for long-term structural protection (Isoptera), Sociobiology, 37:301-310), and a single termite population might be feeding on several food resources at once. However, the palatability of each available resource influences the amount of termite consumption on that resource. For example, subterranean termites consumption of less preferred food items in their environment is diminished when a more desirable resource has been located (Smythe and Carter 1970).

Because a single termite has a limited consumption capacity and cannot consume more than this amount, the total amount of food a termite population can consume in a given period is also limited. As found in the choice assays of this Example 1, consumption of more than one food source at a particular time resulted in all food resources being consumed less than when only a single food source was available. Further, this impact of food resource competition on a particular food was even more pronounced when the termites found the competitor to be more palatable.

These results suggest that as field populations of termites expand their foraging territories and discover new food resources, consumption of established food sources might be considerably reduced. Thus the influence of competing food resources on the efficacy of subterranean termite baiting systems in the field could be quite significant.

### EXAMPLE 1A

The experimental results of Example 1 show that in choice test experiments, cellulose (paper) diets spiked with very low concentrations of inulin are significantly more attractive to termite workers compared to other diet sources tested. Inulin has been identified as useable as a termite attractant in termite baiting systems) have been further considered and analyzed in view of the following.

Only two major groups of organisms, namely, free-living fungi and the microorganisms contained in the digestive track of termites, possess the capability to degrade woody materials. Termite microbes require the anaerobic environment provided in their hindguts to digest the cellulosic lignin complex into smaller carbon units and nutrient molecules. The byproducts of wood digestion by termites consist of smaller units of cellulose and lignins. The subunits of termite-digested cellulose are composed of heteropolymers or heteropolysaccharides, which are β-1→4-linked cellulose units of variable molecular weight. The larger polysaccharides are not water soluble, but smaller units (approximately 5,000 daltons) are water soluble. Smaller glucopyranose units are byproducts of digestion of cellulose by microbes in the termite hindgut, and those glycopyranose units are themselves ultimately degraded to hexoses (glucose). The experimental results (see Example 1) observed for inulin (which is an example of a low molecular weight β-cellulose-derived polymer), making inulin suitable as termite bait (especially as a subterranean termite bait), would be expected for other low molecular weight β-cellulose-derived polymers, such as, for example, β-cellulose-derived polymers consisting of up to 75 hexose units, with molecular weights ranging between 1,000 to 12,600 daltons, which are water soluble or slightly water soluble.

### EXAMPLE 1B

The conclusions from the experimental results of Example 1 concerning Reticulitermes spp. termites may be extended to other termites as follows. There are several other subterranean termite species in the United States that are pests of human structures. These include but are not limited to the Formosan termite Coptotermes formosanus. This termite species lives primarily in the soil and exhibits similar foraging and wood consumption behavior to that of the Reticulitermes sp. However, the Formosan termite is known to have larger colonies and to be more voracious than the Reticulitermes sp. These characteristics make the Formosan termite an even better candidate for termite baits than the Reticulitermes sp. Bait efficacy is determined by the number of termites that are recruited to and consume the bait. Because Formosan termites have large colonies and consume large amounts of food, they are more likely to recruit to and consume significant amounts of a palatable bait. Thus, they will consume enough bait to distribute a lethal dose of the bait toxicant throughout the colony.

### EXAMPLE 2

In laboratory evaluations to determine the attractiveness of inulin as a supplementary termite feeding stimulant, subterranean termites preferentially consumed inulin treated paper towels over untreated towels and yellow pine wood. Subterranean termites, Reticulitermes sp. were reared in the laboratory in Nunc dishes containing strips of yellow pine wood as a food resource and termite harborage. Inulin treated and untreated paper towel diets were weighed and then placed side by side on the top of the termite harborages (strips of yellow pine). Termites were allowed to forage for an average of 7 d. After the test period, the diets were removed, weighed and consumption of each towel diet was recorded as a percentage of total consumption of both paper towel diets. Consumption of the inulin treated diets was significantly greater than that of the untreated diets (Table C). These results indicated that the termites would consume the inulin diets preferentially over the untreated diets and in the presence of their established (long term) food resource, yellow pine.

TABLE C
Termite Consumption

| Test | Diet | n | Mean % ± SEM | t-statistic | P-value |
|---|---|---|---|---|---|
| Choice | Inulin treated | 10 | 64.7 ± 4.5 | −4.41 | 0.0003 |
| Choice | Untreated | 10 | 35.4 + 4.5 | | |

While the invention has been described in terms of its preferred embodiments, those skilled in the art will recognize that the invention can be practiced with modification within the spirit and scope of the appended claims.

What we claim as our invention is:

1. A termite baiting composition, comprising a termite food source that (1) to a termite is not naturally already available as a building or as a living or dead plant; and (2) is easier for the termite to digest compared to a naturally available diet of the termite.

2. The termite baiting composition of claim 1, wherein the easier-to-digest material is smaller than cellulose.

3. The termite baiting composition of claim 1, wherein the easier-to-digest material comprises at least one β-linked carbohydrate.

4. The termite baiting composition of claim 1, wherein the easier-to-digest material is digestible only by termites including digestion by organisms within termites.

5. The termite baiting composition of claim 1, comprising at least one plant-derived β-linked hexose polymer.

6. The termite baiting composition of claim 1, wherein the easier-to-digest material includes one or both selected from the group consisting of β-2→1 linkages and β-2→6 linkages.

7. The termite baiting composition of claim 6, wherein a maximum molecular weight of molecules containing the linkages is about 33,200 Da.

8. The termite baiting composition of claim 6, wherein a maximum molecular weight of molecules containing the linkages is about 12,000 Da.

9. The termite baiting composition of claim 6, wherein a maximum molecular weight of molecules containing the linkages is about 5,000 Da.

10. The termite baiting composition of claim 1, comprising at least one fructan.

11. The termite baiting composition of claim 1, comprising inulins.

12. The termite baiting composition of claim 11, wherein the inulins have a molecular weight in a range of about 3,000 to 5,000 Da.

13. The termite baiting composition of claim 1, comprising levans.

14. The termite baiting composition of claim 13, wherein the levans have a molecular weight in a range of about 16,600 to 33,200 Da.

15. The termite baiting composition of claim 1, wherein the termite food source comprises β-2→1 linkages linking D-fructofuranosyl units.

16. The termite baiting composition of claim 1, wherein the termite food source comprises β-2→6 linkages linking D-fructofuranosyl units.

17. A termite baiting composition, comprising at least one β-linked carbohydrate which is smaller than cellulose, in a form reachable and consumable by termites.

18. The termite baiting composition of claim 17, wherein the β-linked carbohydrate comprises at least one selected from the group consisting of: β-2→1-linked fructofuranosyl units or β-2→6-linked fructofuranosyl units.

19. The termite baiting composition of claim 17, wherein the β-linked carbohydrate is a cellulose-derived polymer.

20. The termite baiting composition of claim 17, wherein the β-linked carbohydrate consists of up to 75 hexose units.

21. The termite baiting composition of claim 17, wherein the β-linked carbohydrate has a molecular weight in a range of 1,000 to 12,600 daltons.

22. The termite baiting composition of claim 17, wherein the β-linked carbohydrate is soluble or slightly soluble in water.

23. The termite baiting composition of claim 17, wherein the composition comprises at least one fructan.

24. The termite baiting composition of claim 23, wherein the fructan is selected from the group consisting of: inulins, levans, and fructofuranosides.

25. The termite baiting composition of claim 17, wherein the composition is coatable, or coated, on a wood material.

26. The termite baiting composition of claim 17, including a ground-up grass containing β-2→6 fructofuranosides.

27. The termite baiting composition of claim 17, including a ground-up grass embedded in a lignocellulosic material.

28. The termite baiting composition of claim 17, including a plant, or a plant derivative, containing β-2→6 fructofuranosides.

29. The termite baiting composition of claim 28, wherein the plant or plant derivative is ground-up Jerusalem artichoke.

30. A method of attracting termites, comprising:
providing, in a first location, an amount of a composition comprising at least one β-2→1-linked carbohydrate which is smaller than cellulose.

31. The method of claim 30, wherein one or more of the following occurs: (A) at least one termite feeds on the composition; (B) at least one termite after feeding on the composition departs the first location, and wherein subsequently further termites, after contact with the composition-consuming termite, come to the first location; (C) after a first termite feeds on the composition and departs the location, the first termite is in contact with additional termites who subsequently arrive at the first location.

32. A method of attracting termites, comprising:
providing, in a first location, an amount of a termite attractant which is a plant-derived β-linked carbohydrate which is not wood, decaying wood or cellulose.

33. A termite baiting station, comprising:
a composition comprising a β-linked carbohydrate which is smaller than cellulose, wherein the composition is disposed in a housing with at least one opening through which termites may travel to reach the composition.

34. A termite baiting station, comprising:
a housing with at least one opening through which termites may travel to reach a termite attractant housed therein;
the termite attractant being a plant-derived β-linked carbohydrate which is not wood, decaying wood or cellulose.

35. A termite attractant comprising:
a composition which is eaten by termites at a faster rate and/or in larger amounts than the termites would eat any other of wood, decaying wood or cellulose.

36. The termite attractant of claim 35, including a β-linked carbohydrate.

37. The termite attractant of claim 35, wherein the β-linked carbohydrate is a cellulose-derived polymer that is smaller than cellulose.

38. The termite attractant of claim 37, including at least one inulin.
